(19) United States
(12) Patent Application Publication
(10) Pub. No.: US 2025/0266208 A1
(43) Pub. Date: Aug. 21, 2025

(54) TRANSFORMER MODULE

(71) Applicants: HYUNDAI MOBIS CO., LTD., Seoul (KR); MOTIVELINK CO., LTD., Yongin-si (KR)

(72) Inventors: Dong Hyuk YANG, Yongin-si (KR); Deok Kwan CHOI, Yongin-si (KR); Yoon CHOI, Yongin-si (KR); Hyun Yong JU, Gwangju-si (KR); Jung Do KANG, Yongin-si (KR); Ji Hoon LEE, Yongin-si (KR); Yun Gyeong CHOI, Yongin-si (KR)

(73) Assignees: HYUNDAI MOBIS CO., LTD., Seoul (KR); MOTIVELINK CO., LTD., Yongin-si (KR)

(21) Appl. No.: 19/058,986

(22) Filed: Feb. 20, 2025

(30) Foreign Application Priority Data
Feb. 20, 2024 (KR) 10-2024-0024597

(51) Int. Cl. H01F 27/33; H01F 27/02; H01F 27/29; H01F 27/30; H01F 27/32

(52) U.S. Cl. CPC H01F 27/33; H01F 27/02; H01F 27/29; H01F 27/306; H01F 27/325

(57) ABSTRACT

A transformer module may include a first bobbin unit around which a primary coil is wound and a second bobbin unit around which a secondary coil is wound and that accommodates at least a portion of the first bobbin unit.

### CROSS-REFERENCE TO RELATED APPLICATION

This application claims the benefit of priority to Korean Patent Application No. 10-2024-0024597, filed in the Korean Intellectual Property Office on Feb. 20, 2024, the entire contents of which are incorporated herein by reference.

### TECHNICAL FIELD

The present disclosure relates to a transformer module, and more particularly, relates to a transformer module for reducing noise generated in an SMPS and decreasing parasitic capacitance.

### BACKGROUND

In order to implement stable operation of an electronic product by improving the quality of power supplied to the electronic product, a filter for removing or minimizing electromagnetic interference (EMI) noise have become increasingly important.

In particular, in the mobility sector, a hybrid vehicle (HEV), a plug-in hybrid vehicle (PHEV), an electric vehicle (EV), and a fuel cell vehicle (FCEV) have attracted attention as environmentally friendly vehicles of the future that will replace vehicles powered by fossil fuels.

Various types of power conversion devices are used in relation to electric vehicles that are being actively commercialized. For example, an on-board charger (OBC) for charging a high-voltage battery from the outside may be used. In another example, a low-voltage DC-DC converter (LDC) for converting power from a high-voltage battery to a low-voltage battery (e.g., a 12V low-voltage battery) may be used.

Electromagnetic interference noise may be generated, maintained, and amplified in the process of charging the high-voltage battery from the outside or in the process of converting the power from the high-voltage battery to the low-voltage battery, and the electromagnetic interference noise may affect the transmission and supply of the power and may cause a malfunction of a load that receives the power (e.g., headlights, wipers, an ECU, and the like that are driven by power supplied from a low-voltage battery).

Meanwhile, in relation to the structure of a transformer, the area where the primary coil is wound and the area where the secondary coil is wound may partially overlap each other to decrease parasitic capacitance and reduce noise when each of the primary coil and the secondary coil forms a wound shape. Depending on the above-described structure, the space occupied by the transformer may be decreased, and thus the transformer may be made compact. However, despite the structure described above, there is a demand for a transformer capable of implementing stable winding of the primary coil and the secondary coil and high power conversion efficiency.

In addition, efforts for making a transformer module compact and minimizing the area occupied by the transformer module when the transformer module is mounted on a substrate are being made.

### PATENT DOCUMENT

(Patent Document 1) Korean Patent No. 10-2359297 (Feb. 8, 2022)

### SUMMARY

The present disclosure has been made to solve the above-mentioned problems occurring in the prior art while advantages achieved by the prior art are maintained intact.

An aspect of the present disclosure provides a compact transformer module for decreasing parasitic capacitance and minimizing noise.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a transformer module includes a first bobbin unit around which a primary coil is wound and a second bobbin unit around which a secondary coil is wound and that accommodates at least a portion of the first bobbin unit.

The first bobbin unit may include a first winding part on which the primary coil is wound around a portion of an outer peripheral surface of the first winding part, and the second bobbin unit may include a second winding part on which the secondary coil is wound around a portion of an outer peripheral surface of the second winding part. The outer peripheral surface of the first winding part may correspond to an inner peripheral surface of the second winding part and may be covered by the second winding part.

The first winding part may include a first winding area where the primary coil is directly wound around an outer peripheral surface of the first winding area, a first side plate formed at one end of the first winding area to protrude outward from the outer peripheral surface of the first winding area, a second side plate formed at an opposite end of the first winding area to protrude outward from the outer peripheral surface of the first winding area, the second side plate being configured to face the first side plate, and at least one first winding area partition unit that is formed between the first side plate and the second side plate and that protrudes outward from the outer peripheral surface of the first winding area.

The second winding part may include a second winding area where the secondary coil is directly wound around an outer peripheral surface of the second winding area, a third side plate formed at one end of the second winding area to protrude outward from the outer peripheral surface of the second winding area, a fourth side plate formed at an opposite end of the second winding area to protrude outward from the outer peripheral surface of the second winding area, the fourth side plate being configured to face the third side plate, and at least one second winding area partition unit that is formed between the third side plate and the fourth side plate and that protrudes outward from the outer peripheral surface of the second winding area, and the at least one first winding area partition unit and the at least one second winding area partition unit may be formed at the same position in a longitudinal direction.

Each of the at least one first winding area partition unit and the at least second winding area partition unit may be formed in the same number, n. Each of the primary coil and secondary coil may be wound to form (n+1) channels by the at least one first winding area partition unit and the at least one second winding area partition unit (n being an integer of 1 or more).

A second side plate outer surface of the second side plate and a fourth side plate inner surface of the fourth side plate may make surface-to-surface contact with each other, and a first side plate outer surface of the first side plate and a third side plate outer surface of the third side plate may be arranged on the same plane by the surface contact between the second side plate outer surface and the fourth side plate inner surface.

The first bobbin unit may further include a first extension part that extends outward from one end of the first winding part by a certain length, and the first extension prat may include a first step portion that extends in a longitudinal direction from a first side plate formed at one end of a first winding area of the first winding part and a second step portion that protrudes outward from the first step portion in a width direction and forms a step of a first thickness with the first step portion.

The second bobbin unit may further include a second extension part that extends outward from one end of the second winding part by a certain length, and the second extension part may include a first fixing portion that extends in the longitudinal direction from a third side plate formed at one end of a second winding area of the second winding part and a second fixing portion that protrudes inward from the first fixing portion in the width direction and protrudes downward from an upper surface of the first fixing portion by a second thickness.

The first thickness formed by the first step portion and the second step portion and the second thickness of the second fixing portion may correspond to each other to guide insertion of the first winding part into the second winding part, and the first bobbin unit may be located in a correct position with respect to the second bobbin unit.

The first bobbin unit may further include a first terminal portion that protrudes from one end of a first extension part that extends outward from one end of the first winding part by a certain length, the second bobbin unit may further include a second terminal portion that protrudes from one end of a second extension part that extends outward from one end of the second winding part by a certain length, and the first terminal portion and the second terminal portion may be spaced apart from each other.

The first bobbin unit may further include a first terminal portion that protrudes from one end of a first extension part that extends outward from one end of the first winding part by a certain length, the second bobbin unit may further include a second terminal portion that protrudes from one end of a second extension part that extends outward from one end of the second winding part by a certain length, and the first terminal portion and a one-side second terminal portion of the second terminal portion may be arranged on the same line.

The first bobbin unit may further include a first extension part that extends outward from one end of the first winding part by a certain length, and the second bobbin unit may further include a second extension par that extends outward from one end of the second winding part by a certain length. The first extension part may include a side protruding portion that protrudes outward in a width direction, and the second extension part may include a side receiving portion that is recessed outward in the width direction and that has a shape corresponding to a shape of the side protruding portion. The side protruding portion may be accommodated in the side receiving portion to guide insertion of the first winding part into the second winding part, and the first bobbin unit may be located in a correct position with respect to the second bobbin unit.

The first bobbin unit may further include a first terminal portion including a plurality of first terminals that protrude from one end of a first extension part that extends outward from one end of the first winding part by a certain length. The second bobbin unit may further include a second terminal portion including a plurality of second terminals that protrude from one end of a second extension part that extends outward from one end of the second winding part by a certain length. Each of the plurality of first terminals and the plurality of second terminals may extend in a longitudinal direction or a width direction.

The transformer module may further include a cap unit that covers at least a portion of the first bobbin unit and at least a portion of the second bobbin unit, and the cap unit may cover at least a portion of the outer peripheral surface of the first winding part and at least a portion of the outer peripheral surface of the second winding part.

The cap unit may include a cap unit upper-surface portion that covers an upper portion of the second winding part, a pair of cap unit side portions that cover opposite ends of the first winding part and the second winding part, and a pair of cap fixing portions that extend inward from the pair of cap unit side portions toward the first bobbin unit and the second bobbin unit in a longitudinal direction.

The transformer module may further include a core unit including a core center portion that penetrates the first bobbin unit and the second bobbin unit, and a core side portion that is spaced apart from the core center portion and that covers at least a portion of an outside of the first bobbin unit and at least a portion of an outside of the second bobbin unit.

The transformer module may further include a bending unit that surrounds at least a portion of an outer surface of the core unit.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a transformer module according to a disclosed embodiment of the present disclosure;

FIG. 2 is a perspective view of the transformer module excluding a cap unit according to the disclosed embodiment of the present disclosure;

FIG. 3 is an exploded perspective view of the transformer module according to the disclosed embodiment of the present disclosure;

FIG. 4 is a view for explaining a first bobbin unit, which is a component of the transformer module, according to the disclosed embodiment of the present disclosure;

FIG. 5 is a view for explaining a second bobbin unit, which is a component of the transformer module, according to the disclosed embodiment of the present disclosure;

FIG. 6 is a view for explaining a relationship between the first bobbin unit and the second bobbin unit in the transformer module according to the disclosed embodiment of the present disclosure;

FIG. 7 is a perspective view of a transformer module according to another embodiment of the present disclosure;

FIG. 8 is an exploded perspective view of the transformer module according to the other embodiment of the present disclosure;

FIG. 9 is a perspective view of a transformer module according to another embodiment of the present disclosure; and

FIG. 10 is an exploded perspective view of the transformer module according to the other embodiment of the present disclosure.

### DETAILED DESCRIPTION

The above and other aspects, features, and advantages of the present disclosure will become apparent from the following description of embodiments given in conjunction with the accompanying drawings. However, the present disclosure is not limited to the embodiments disclosed herein and may be implemented in various different forms. Herein, the embodiments are provided to provide complete disclosure of the present disclosure and to provide thorough understanding of the present disclosure to those skilled in the art to which the present disclosure pertains, and the scope of the present disclosure should be limited only by the accompanying claims and equivalents thereof.

It will be understood that, although the terms first, second, etc. may be used herein to describe various components, these components should not be limited by these terms. These terms are only used to distinguish one component from another component. Thus, a first component mentioned below could be termed a second component without departing from the spirit of the present disclosure.

Through the specification, identical reference numerals refer to identical components.

The features of various embodiments of the present disclosure can be partially or entirely coupled to or combined with each other and can be interlocked and operated in technically various ways as can be fully understood by those skilled in the art, and the embodiments can be carried out independently of or in association with each other.

Meanwhile, the potential effects that may be expected by the technical features of the present disclosure that are not specifically mentioned in the specification of the present disclosure are treated as being described in this specification, and this embodiment is provided to more fully describe the present disclosure for those skilled in the art. Thus, the contents illustrated in the drawings may be exaggerated compared to the actual implementation of the present disclosure, and detailed descriptions of components determined to unnecessarily make subject matters of the present disclosure obscure will be omitted or briefly described.

Hereinafter, disclosed embodiments of the present disclosure will be described in detail with reference to the accompanying drawings.

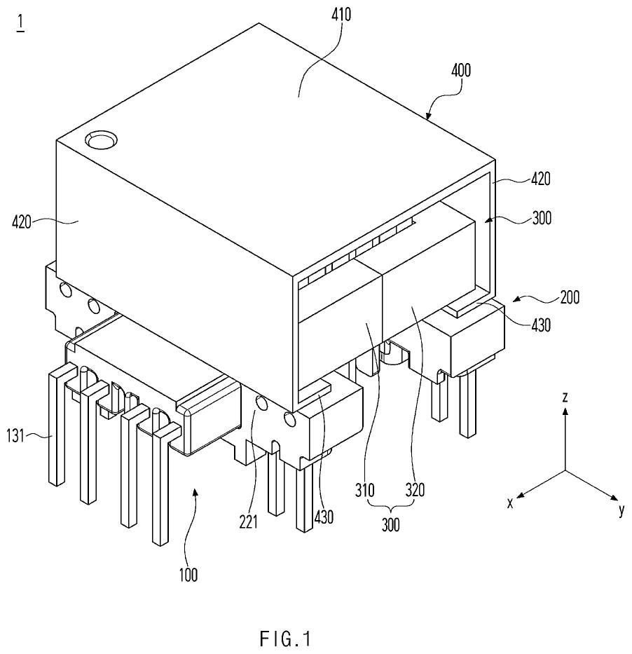

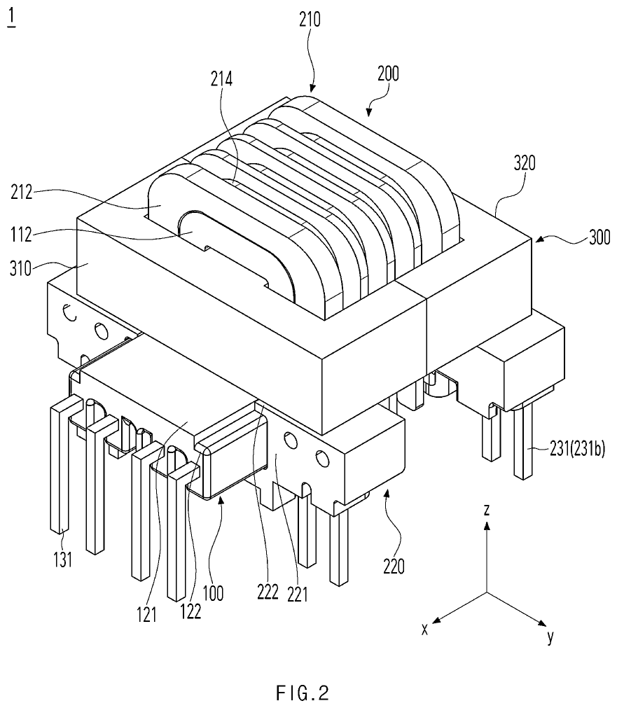

FIG. 1 is a perspective view of a transformer module 1 according to a disclosed embodiment of the present disclosure, and FIG. 2 is a perspective view of the transformer module excluding a cap unit according to the disclosed embodiment of the present disclosure.

Referring to FIGS. 1 and 2, the transformer module 1 according to the disclosed embodiment of the present disclosure may include a first bobbin unit 100 and a second bobbin unit 200. In addition, the transformer module 1 according to the disclosed embodiment of the present disclosure may include a coil unit (not illustrated) and a core unit 300.

The first bobbin unit 100 may be a component around which a primary coil is wound. In more detail, the primary coil of the coil unit may be wound around an outer peripheral surface of at least a portion of the first bobbin unit 100. As current flows through the primary coil, magnetic flux may be generated, and an induced electromotive force may be generated.

The second bobbin unit 200 may be a component around which a secondary coil is wound. In more detail, the secondary coil of the coil unit may be wound around an outer peripheral surface of at least a portion of the second bobbin unit 200. As current flows through the secondary coil, magnetic flux may be generated, and an induced electromotive force may be generated. The second bobbin unit 200 may accommodate at least a portion of the first bobbin unit 100. As the second bobbin unit 200 accommodates the at least a portion of the first bobbin unit 100, the primary coil wound around the outer peripheral surface of the at least a portion of the first bobbin unit 100 may be more safely protected from an external environment, and the area around which the primary coil is wound and the area around which the secondary coil is wound may at least partially overlap each other. Accordingly, the magnitude of parasitic capacitance generated in a power conversion process may be decreased, and noise (that is, EMI noise) may be minimized.

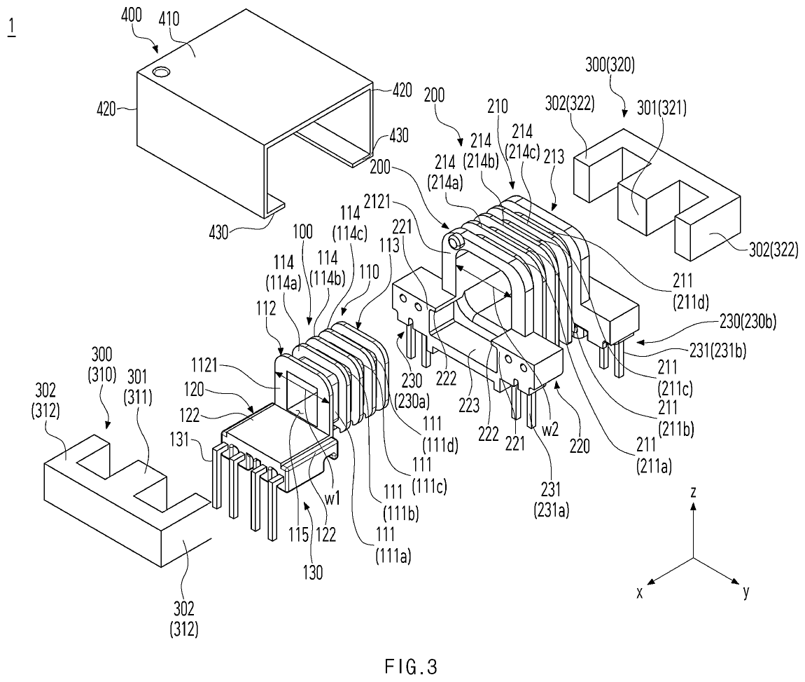

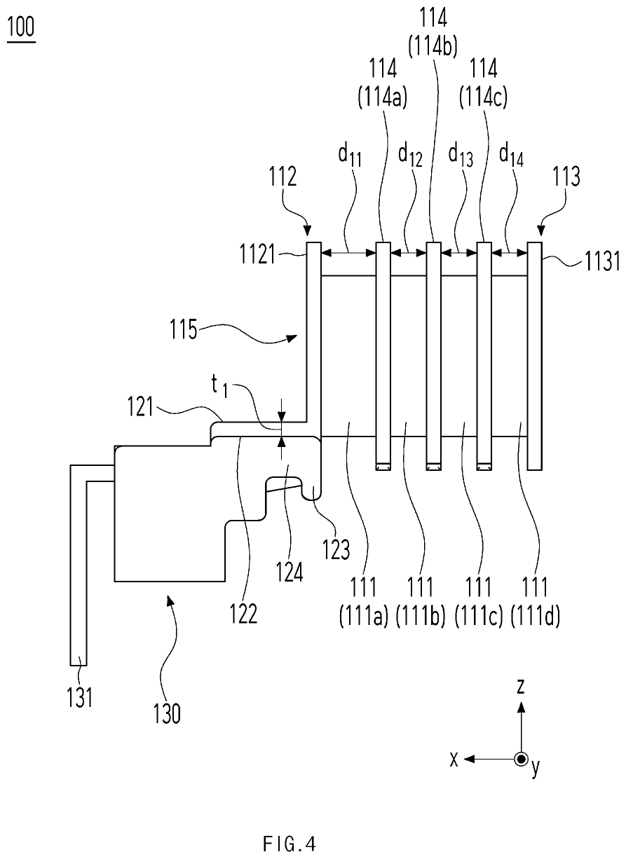

Although the coil unit is not clearly illustrated in the drawings accompanied to describe the transformer module according to the present disclosure, the coil unit may be wound around a first winding area 111 (refer to FIGS. 2 to 4) of a first winding part 110 (refer to FIGS. 2 to 4) and a second winding area 211 (refer to FIGS. 3 and 4) of a second winding part 210 (refer to FIGS. 3 and 4). The coil unit may include the primary coil and the secondary coil. The primary coil may be wound around the first winding area 111, and the secondary coil may be wound around the second winding area 211.

The core unit 300 may serve to absorb and/or form magnetic flux generated from the above-described coil unit and transfer a voltage generated in the primary coil to the secondary coil. The core unit 300 may serve as a passage that coverts power in the primary coil into power in the secondary coil.

Hereinafter, detailed components of the transformer module 1 according to the disclosed embodiment of the present disclosure will be described in more detail.

FIG. 3 is an exploded perspective view of the transformer module 1 according to the disclosed embodiment of the present disclosure, FIG. 4 is a view for explaining the first bobbin unit 100, which is a component of the transformer module 1, according to the disclosed embodiment of the present disclosure, and FIG. is a view for explaining the second bobbin unit 200, which is a component of the transformer module 1, according to the disclosed embodiment of the present disclosure.

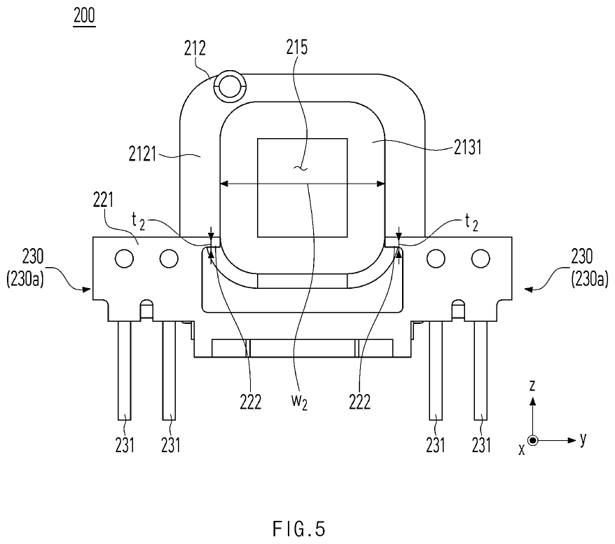

Referring to FIGS. 1 to 5, the first bobbin unit 100, which is a component of the transformer module 1 according to the disclosed embodiment of the present disclosure, may include the first winding part 110. The first winding part 110 may be an area around which the primary coil is wound in the first bobbin unit 100. That is, the primary coil may be wound around a portion of an outer peripheral surface of the first winding part 110. Accordingly, the wound primary coil may generate magnetic flux to generate an induced electromotive force.

The second bobbin unit 200, which is a component of the transformer module 1 according to the disclosed embodiment of the present disclosure, may include the second winding part 210. The second winding part 210 may be an area around which the secondary coil is wound in the second bobbin unit 200. That is, the secondary coil may be wound around a portion of an outer peripheral surface of the second winding part 210. Accordingly, the wound secondary coil may generate magnetic flux to generate an induced electromotive force or may transfer transferred power to a load.

Meanwhile, the outer peripheral surface of the first winding part 110 may correspond to the inner peripheral surface of the second winding part 210. The outer peripheral surface of the first winding part 110 may be covered by the second winding part 210. For example, the size of the outer width w1 on the first winding part side, which represents the outer peripheral surface of the first winding part 110, may correspond to the inner width w2 on the second winding part side, which represents the inner peripheral surface of the second winding part 210. In more detail, the outer width w1 on the first winding part side may be less than or equal to the inner width w2 on the second winding part side. Accordingly, the outer peripheral surface of the first winding part 110 may be entirely covered by the second winding part 210. Thus, the primary coil wound around the first winding part 110 may be more safely protected from an external environment, and a decrease in parasitic capacitance and minimization of noise may be achieved.

Hereinafter, detailed components of the first winding part 110 will be described in more detail.

In the first bobbin unit 100 of the transformer module 1 according to the disclosed embodiment of the present disclosure, the first winding part 110 may include the first winding area 111. The first winding area 111 may be an area where the primary coil is directly wound around the outer peripheral surface thereof. The first winding area 111 may include at least one channel first winding area 111a, 111b, 111c, and 111d. For example, the first winding area 111 may include the first channel first winding area 111a, the second channel first winding area 111b, the third channel first winding area 111c, and the fourth channel first winding area 111d, and the channel first winding areas 111a, 111b, 111c, and 111d may form a plurality of channels in correspondence with the second winding area 211 to be described below.

The first winding part 110 may include a first side plate 112. The first side plate 112 may be formed at one end of the first winding area 111 to protrude outward from the outer peripheral surface of the first winding area 111. The first side plate 112 may have a width and/or a height greater than the width (e.g., a length parallel to the y-axis) and/or or the height (e.g., a length parallel to the z-axis) of the first winding area 111. The first side plate 112 may prevent the primary coil wound around the first winding area 111 from passing over the first side plate 112 and departing from the first winding part 110 to one side.

The first winding part 110 may include a second side plate 113. The second side plate 113 may be formed at an opposite end of the first winding area 111 to protrude outward from the outer peripheral surface of the first winding area 111. The second side plate 113 may have a width and/or a height greater than the width (e.g., a length parallel to the y-axis) and/or or the height (e.g., a length parallel to the z-axis) of the first winding area 111. The second side plate 113 may be formed to face the first side plate 112 in the longitudinal direction (e.g., a direction parallel to the x-axis). The second side plate 113 may prevent the primary coil wound around the first winding area 11 from passing over the second side plate 113 and departing from the first winding part 110 to the opposite side.

The first winding part 110 may include at least one first winding area partition unit 114 formed on the first winding area 111. In more detail, the at least one first winding area partition unit 114 may be formed between the first side plate 112 and the second side plate 113 and may protrude outward from the outer peripheral surface of the first winding area 111. As illustrated in FIGS. 3 and 4, the first winding area partition unit 114 may include three first winding area partition units 114a, 114b, and 114c, and due to the first winding area partition units 114a, 114b, and 114c, the first winding area 111 may include the first channel first winding area 111a having a first length d11, the second channel first winding area 111b having a second length d12, the third channel first winding area 111c having a third length d13, and the fourth channel first winding area 111d having a fourth length d14. That is, depending on the number of first winding area partition units 114, the channel first winding areas 111a, 111b, 111c, and 111d one more than the number of first winding area partition units 114 may be formed.

Hereinafter, detailed components of the second winding part 210 will be described in more detail.

In the second bobbin unit 200 of the transformer module 1 according to the disclosed embodiment of the present disclosure, the second winding part 210 may include the second winding area 211. The second winding area 211 may be an area where the secondary coil is directly wound around the outer peripheral surface thereof. The second winding area 211 may include at least one channel second winding area 211a, 211b, 211c, and 211d. For example, the second winding area 211 may include the first channel second winding area 211a, the second channel second winding area 211b, the third channel second winding area 211c, and the fourth channel second winding area 211d. The channel second winding areas 211a, 211b, 211c, and 211d may form a plurality of channels in correspondence with the above-described first winding area 111.

The second winding part 210 may include a third side plate 212. The second side plate 212 may be formed at one end of the second winding area 211 to protrude outward from the outer peripheral surface of the second winding area 211. The third side plate 212 may have a width and/or a height greater than the width (e.g., a length parallel to the y-axis) and/or or the height (e.g., a length parallel to the z-axis) of the second winding area 211. The third side plate 212 may prevent the secondary coil wound around the second winding area 211 from passing over the third side plate 212 and departing from the second winding part 210 to one side.

The second winding part 210 may include a fourth side plate 213. The fourth side plate 213 may be formed at an opposite end of the second winding area 211 to protrude outward from the outer peripheral surface of the second winding area 211. The fourth side plate 213 may have a width and/or a height greater than the width (e.g., a length parallel to the y-axis) and/or or the height (e.g., a length parallel to the z-axis) of the second winding area 211. The fourth side plate 213 may be formed to face the third side plate 212 in the longitudinal direction (e.g., a direction parallel to the x-axis). The fourth side plate 213 may prevent the secondary coil wound around the second winding area 211 from passing over the fourth side plate 213 and departing from the second winding part 210 to the opposite side.

The second winding part 210 may include at least one second winding area partition unit 214 formed on the second winding area 211. In more detail, the at least one second winding area partition unit 214 may be formed between the third side plate 212 and the fourth side plate 213 and may protrude outward from the outer peripheral surface of the second winding area 211. As illustrated in FIGS. 3 to 5, the second winding area partition unit 214 may include three second winding area partition units 214a, 214b, and 214c, and due to the second winding area partition units 214a, 214b, and 214c, the second winding area 211 may include the first channel second winding area 211a having a fifth length d21, the second channel second winding area 211b having a sixth length d22, the third channel second winding area 211c having a seventh length d23, and the fourth channel second winding area 211d having an eighth length d24. That is, depending on the number of second winding area partition units 214, the channel second winding areas 211a, 211b, 211c, and 211d one more than the number of second winding area partition units 214 may be formed.

Hereinafter, a physical relationship between the first bobbin unit 100 and the second bobbin unit 200 in the transformer module 1 according to the disclosed embodiment of the present disclosure will be described in more detail.

First, a relationship between the first winding part 110 of the first bobbin unit 100 and the second winding part 210 of the second bobbin unit 200 in the transformer module 1 according to the disclosed embodiment of the present disclosure will be described.

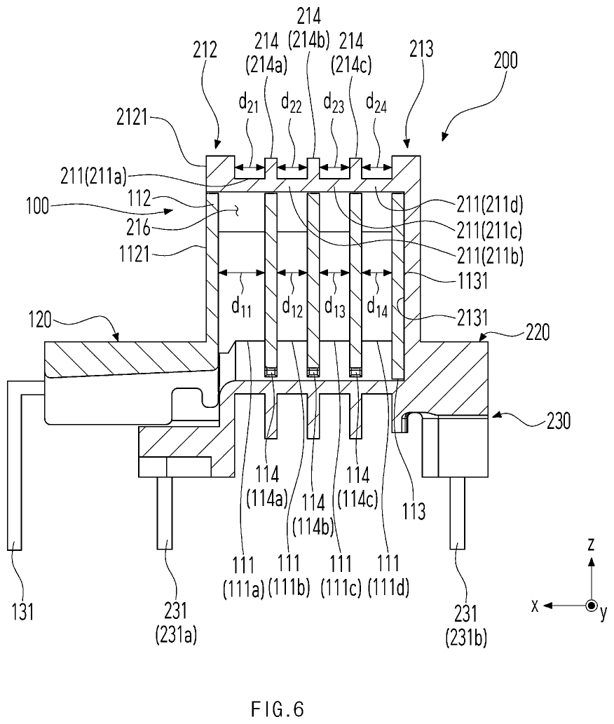

FIG. 6 is a view for explaining a relationship between the first bobbin unit 100 and the second bobbin unit 200 in the transformer module 1 according to the disclosed embodiment of the present disclosure.

Referring to FIGS. 1 to 6, the at least one first winding area partition unit 114 and the at least one second winding area partition unit 214 may be formed at the same position in the longitudinal direction (e.g., a direction parallel to the x-axis) As illustrated in FIG. 6, the first winding area partition units 114a, 114b, and 114c may be arranged on the same planes as the corresponding second winding area partition units 214a, 214b, and 214c, respectively. Accordingly, the channel first winding areas 111a, 111b, 111c, and 111d and the channel second winding areas 211a, 211b, 211c, and 211d may be formed to correspond to each other. For example, the first length d11 of the first channel first winding area 111a may correspond to the fifth length d21 of the first channel second winding area 211a. The second length d12 of the second channel first winding area 111b may correspond to the sixth length d22 of the second channel second winding area 211b. The third length d13 of the third channel first winding area 111c may correspond to the seventh length d23 of the third channel second winding area 211c. The fourth length d14 of the fourth channel first winding area 111d may correspond to the eighth length d24 of the fourth channel second winding area 211d. Accordingly, the coil unit wound around the first channel winding area 111a and 211a, the coil unit wound around the second channel winding area 111b and 211b, the coil unit wound around the third channel winding area 111c and 211c, and the coil unit wound around the fourth channel winding area 111d and 211d may have the same wound length. Thus, parasitic capacitance may be decreased, and noise may be minimized. In addition, as the coil unit is uniformly wound, a difference in capacitance between the plurality of channels may be minimized, and thus the electrical stability of the transformer module may be further improved.

Although, as illustrated in FIGS. 1 to 6, the at least one first winding area partition unit 114 includes three first winding area partition units and the at least one second winding area partition unit 214 includes three second winding area partition units, the number of first winding area partition units and the number of second winding area partition units are not necessarily limited thereto. Each of the at least one first winding area partition unit 114 and the at least one second winding area partition units 214, is formed in the same number, n. For example, the at least one first winding area partition unit 114 may include n first winding area partition units, and the at least one second winding area partition unit 214 may include n second winding area partition units. In this case, n may be an integer of 1 or more. The at least one first winding area partition unit 114 may include n first winding area partition units arranged at equal intervals between the first side plate 112 and the second side plate 113, and the at least one second winding area partition unit 214 may include n second winding area partition units arranged at equal intervals between the third side plate 212 and the fourth side plate 213. Due to the n first winding area partition units and the n second winding area partition units, each of the primary coil and the secondary coil may be wound to form (n+1) channels. Accordingly, the transformer module 1 according to the disclosed embodiment of the present disclosure may have a structure capable of forming a required number of channels optimized for power conversion of an electronic product.

Meanwhile, depending on the structure in which the first winding part 110 of the first bobbin unit 100 is accommodated in the second winding part 210 of the second bobbin unit 200, the coil unit wound around each of the first winding area 111 and the second winding area 211 may be located in a correct position. In more detail, a second side plate outer surface 1131 that is an outer surface (e.g., a portion formed parallel to the yz-plane toward the negative x-axis direction) of the second side plate 113 may make surface-to-surface contact with a fourth side plate inner surface 2131 that is an inner surface (e.g., a portion formed parallel to the yz-plane toward the positive x-axis direction) of the fourth side plate 213. That is, the first winding part 110 may be inserted to the position where the fourth side plate inner surface 2131 is formed, and the second side plate outer surface 1131 may physically interfere with the fourth side plate inner surface 2131 such that a movement of the second side plate outer surface 1131 in the longitudinal direction (e.g., in the negative x-axis direction in which the first winding part 110 is inserted into the second winding part 210) is limited. Accordingly, the first winding part 110 may be positioned at a certain position in relation to the second winding part 210. In particular, the first winding area 111 and the second winding area 211 may be arranged to correspond to each other.

Due to the surface contact between the second side plate outer surface 1131 and the fourth side plate inner surface 2131, a first side plate outer surface 1121 that is an outer surface (e.g., a portion formed parallel to the yz-plane toward the positive x-axis direction) of the first side plate 112 and a third side plate outer surface 2121 that is an outer surface (e.g., a portion formed parallel to the yz-plane toward the positive x-axis direction) of the third side plate 212 may be arranged on the same plane. That is, the first side plate outer surface 1121 and the third side plate outer surface 2121 may be arranged on the same plane so that a receiving space 216 of the second winding part 210 may be sealed so as to be safely protected from an external environment. Accordingly, the primary coil of the coil unit wound around the first winding part 110 may be safely protected.

Hereinafter, a first extension part 120 of the first bobbin unit 100 and a second extension part 220 of the second bobbin unit 200 will be described.

Referring to FIGS. 1 to 6, the first bobbin unit 100, which is a component of the transformer module 1 according to the disclosed embodiment of the present disclosure, may include the first extension part 120. For example, the first extension part 120 may extend a certain length from one end of the first winding part 110 in the outer longitudinal direction (e.g., the x-axis direction).

The first extension part 120 may include a first step portion 121 and a second step portion 122. For example, the first step portion 121 may extend in the longitudinal direction (e.g., the positive x-axis direction) from the first side plate 112 formed at the one end of the first winding area 111 of the first winding part 110. The first step portion 121 may form a central portion in the first extension part 120 based on the width direction. The second step portion 122 may protrude outward from the first step portion 121 in the width direction. The second step portion 122 may form a step of a first thickness t1 with the first step portion 121. In more detail, the second step portion 122 may protrude from the first step portion 121 to opposite sides in the width direction, and the upper surface of the second step portion 122 may be recessed in the lower direction (e.g., the negative z-axis direction) by the first thickness t1 with respect to the upper surface of the first step portion 121.

Correspondingly, the second bobbin unit 200, which is a component of the transformer module 1 according to the disclosed embodiment of the present disclosure, may include the second extension part 220. For example, the second extension part 220 may extend outward from one end of the second winding part 210 by a certain length. In this case, the direction in which the second extension part 220 extends from the one end of the second winding part 210 may be the same direction (e.g., the positive x-axis direction) as the direction in which the first extension part 120 extends from the one end of the first winding part 110.

The second extension part 220 may include a first fixing portion 221 and a second fixing portion 222. For example, the first fixing portion 221 may extend in the longitudinal direction (e.g., the positive x-axis direction) from the third side plate 212 formed at the one end of the second winding area 211 of the second winding part 210. The first fixing portion 221 may have an elongated shape in the up-down direction (e.g., the positive z-axis direction or the negative z-axis direction) to cover the above-described first extension part 120 from the outside in the width direction. The second fixing portion 222 may protrude inward from the first fixing portion 221 in the width direction. The second fixing portion 222 may protrude downward from the upper surface of the first fixing portion 221 by a second thickness t2.

Meanwhile, the first thickness t1 of the step formed between the first step portion 121 and the second step portion 122 and the second thickness t2 of the second fixing portion 22 may correspond to each other. For example, the first thickness t1 may be equal to the second thickness t2. Accordingly, in the process in which the first winding part 110 of the first bobbin unit is inserted to be accommodated in the second winding part 210 of the second bobbin unit 200, a kind of rail structure may be formed to guide the insertion of the first winding part 110. In addition, depending on the relationship between the first thickness t1 and the second thickness t2, a movement of the first winding part 110 of the first bobbin unit 100 in the up-down direction may be limited after the first winding part 110 of the first bobbin unit 100 is accommodated in the second winding part 210 of the second bobbin unit 200, and thus the first bobbin unit 100 may be located in a correct position with respect to the second bobbin unit 200 to form a stable assembly structure.

The transformer module 1 according to the disclosed embodiment of the present disclosure may further include the core unit 300. At least a portion of the core unit 300 may penetrate the first bobbin unit 100 and the second bobbin unit 200, and the remaining portion of the core unit 300 may cover the outside of the first bobbin unit 100 and the outside of the second bobbin unit 200.

In more detail, the core unit 300 may include a core center portion 301 that penetrates the first bobbin unit 100 and the second bobbin unit 200. To accommodate the core center portion 301, the first winding part 110 of the first bobbin unit 100 may include a first core receiving hole 115 that is open in the longitudinal direction, and the second winding part 210 of the second bobbin unit 200 may include a second core receiving hole 215 that is open in the longitudinal direction. When the core unit 300 is formed by coupling a first core unit 310 and a second core unit 320, a first core center portion 311 of the first core unit 310 may be inserted through one side of the first core receiving hole 115 and one side of the second core receiving hole 215, and a second core center portion 321 of the second core unit 320 may be inserted through an opposite side of the first core receiving hole 115 and an opposite side of the second core receiving hole 215.

The core unit 300 may include a core side portion 302 that covers at least a portion of the outside of the first bobbin unit 100 and at least a portion of the outside of the second bobbin unit 200. For example, the core side portion 302 may cover at least a portion of opposite side surfaces of the second bobbin unit 200 that face in the width direction. The core side portion 302 may be spaced apart from the core center portion 301. When the core unit 300 is formed by coupling the first core unit 310 and the second core unit 320, a pair of first core side portions 312 of the first core unit 310 and a pair of second core side portions 322 of the second core unit 320 may cover part of an outer portion of the second winding part 210 of the second bobbin unit 200 that faces in the width direction.

In the transformer module 1 according to the disclosed embodiment of the present disclosure, a protruding portion 123 and a concave portion 124 may be formed at the bottom of the first extension part 120 of the first bobbin unit 100, and a space for connecting the primary coil to a first terminal 131 of a first terminal portion 130 may be formed by the protruding portion 123 and the concave portion 124. The second bobbin unit 200 may also be connected with a second terminal 231 of a second terminal portion 230 through a coil receiving passage formed at the bottom of the second extension part 220. If necessary, the second terminal portion 230 may include a one-side second terminal portion 230a and an opposite-side second terminal portion 230b, and the one-side second terminal portion 230a and the opposite-side second terminal portion 230b may include a one-side second terminal 231a and an opposite-side second terminal 231b, respectively. Accordingly, the secondary coil may be connected to the corresponding second terminal portion 230 to form a power conversion and transmission path.

In the transformer module 1 according to the disclosed embodiment of the present disclosure, the first bobbin unit 100 may include the first terminal portion 130. The first terminal portion 130 may protrude from one end of the first extension part 120 that extends outward from the one end of the first winding part 110 by the certain length. The first terminal portion 130 may include a plurality of first terminals 131. The first terminal portion 130 may extend a certain length from the bottom of the one end of the first extension part 120 in the lower direction (e.g., the negative z-axis direction). The first terminal portion 130 may form a mechanical and electrical connection with a substrate (not illustrated) by being inserted into the substrate and soldered to the substrate, such that the transformer module 1 according to the disclosed embodiment of the present disclosure performs a transformer function.

In the transformer module 1 according to the disclosed embodiment of the present disclosure, the second bobbin unit 200 may include the second terminal portion 230. The second terminal portion 230 may protrude from one end of the second extension part 220 that extends outward from the one end or the opposite ends of the second winding part 210 by the certain length. The second terminal portion 230 may include a plurality of second terminals 231. The second terminal portion 230 may extend a certain length from the bottom of the one end of the second extension part 220 in the lower direction (e.g., the negative z-axis direction). The second terminal portion 230 may form a mechanical and electrical connection with the substrate (not illustrated) by being inserted into the substrate and soldered to the substrate, such that the transformer module 1 according to the disclosed embodiment of the present disclosure performs a transformer function.

Meanwhile, the first terminal portion 130 and the second terminal portion 230 may be spaced apart from each other. In more detail, the first terminal portion 130 and the second terminal portion 230 may be inserted into the substrate, but may be spaced apart from each other at a certain interval in a certain direction (e.g., a direction parallel to the x-axis). That is, a safe distance may be secured between the first terminal portion 130 and the second terminal portion 230. Since the first terminal portion 130 and the second terminal portion 230 are spaced apart from each other, electrical influence between the plurality of first terminals 131 of the first terminal portion 130 and the plurality of second terminals 231 of the second terminal portion 230 may be minimized. Accordingly, the transformer module 1 may be applied to a high-voltage and high-power system (e.g., an 800V-class system) to perform a transformer function.

Hereinafter, the cap unit 400, which is a component of the transformer module 1 according to the disclosed embodiment of the present disclosure, will be described. However, the cap unit 400 may also be included in a transformer module 2 and a transformer module 3 according to other embodiments to be described below.

Referring to FIGS. 1 and 3, the transformer module 1 according to the disclosed embodiment of the present disclosure may further include the cap unit 400. The cap unit 400 may cover at least a portion of the first bobbin unit 100 and at least a portion of the second bobbin unit 200. The cap unit 400 may serve to minimize physical and electrical interference between the coil unit wound around each of the first bobbin unit 100 and the second bobbin unit 200 and other components when the transformer module 1 according to the disclosed embodiment of the present disclosure is disposed inside an electronic product. For example, the cap unit 400 may cover at least a portion of the outer peripheral surface of the first winding part 110 of the first bobbin unit 100 and at least a portion of the outer peripheral surface of the second winding part 210 of the second bobbin unit 200. Substantially, the cap unit 400 may cover at least a portion of the outer peripheral surface of the second winding part 210 of the second bobbin unit 200 because the outer peripheral surface of the first winding part 110 corresponds to the inner peripheral surface of the second winding part 210 so that the outer peripheral surface of the first winding part 110 is covered by the second winding part 210.

The cap unit 400 may include a cap unit upper-surface portion 410, a pair of cap unit side portions 420, and a pair of cap fixing portions 430.

The cap unit upper-surface portion 410 may cover an upper portion of the second winding part 210. In more detail, the cap unit upper-surface portion 410 may be spaced apart from the upper portion of the second winding part 210 by a certain height. Accordingly, the cap unit upper-surface portion 410 may prevent other objects from interfering with the second winding part 210. Meanwhile, the cap unit upper-surface portion 410 may include a pin indication portion recessed from the upper surface thereof by a certain depth in the lower direction. The pin indication portion may indicate the position where the first pin of the first bobbin unit 100 and/or the second bobbin unit 200 is disposed in the transformer module 1 according to the disclosed embodiment of the present disclosure.

The pair of cap unit side portions 420 may cover opposite ends of the first winding part 110 and the second winding part 210. In more detail, one of the pair of cap unit side portions 420 may be formed to face toward the first side plate 112 of the first winding part 110 and the third side plate 212 of the second winding part 210. That is, the one of the pair of cap unit side portions 420 may cover the one end of the first winding part 110 and the one end of the second winding part 210. In addition, the other one of the pair of cap unit side portions 420 may be formed to face toward the second side plate 113 of the first winding part 110 and the fourth side plate 213 of the second winding part 210. That is, the other one of the pair of cap unit side portions 420 may cover the opposite end of the first winding part 110 and the opposite end of the second winding part 210. As described above, the pair of cap unit side portions 420 may cover the first winding part 110 and the second winding part 210, thereby safely protecting the first winding part 110, the second winding part 210, and the coil unit wound around the first winding part 110 and the second winding part 210 from an external environment.

The cap unit 400 may include the pair of cap fixing portions 430. The pair of cap fixing portions 430 may extend inward from the pair of cap unit side portions 420 toward the first bobbin unit 100 and the second bobbin unit 200 in the longitudinal direction (e.g., a direction parallel to the x-axis) One of the pair of cap fixing portions 430 may extend from a distal end of one cap unit side portion toward the first side plate 112 of the first winding part 110 and the third side plate 212 of the second winding part 210, and the other cap fixing portion may extend from a distal end of the other cap unit side portion toward the second side plate 113 of the first winding part 110 and the fourth side plate 213 of the second winding part 210. The pair of cap fixing portions 430 may be disposed on the first extension part 120 of the first bobbin unit 100 and/or the second extension part 220 of the second bobbin unit 200 and may be disposed under the core unit 300. Accordingly, the cap unit 400 may form a stable arrangement structure in the transformer module 1 according to the disclosed embodiment of the present disclosure and may safely protect the first winding part 110, the second winding part 210, the coil unit wound around the first winding part 110 and the second winding part 210, and the core unit 300 from an external environment.

Hereinafter, the transformer module 2 according to another embodiment of the present disclosure will be described. In describing the transformer module 2 according to the other embodiment of the present disclosure, contents identical to the above-described ones will be briefly described or will be omitted from the description.

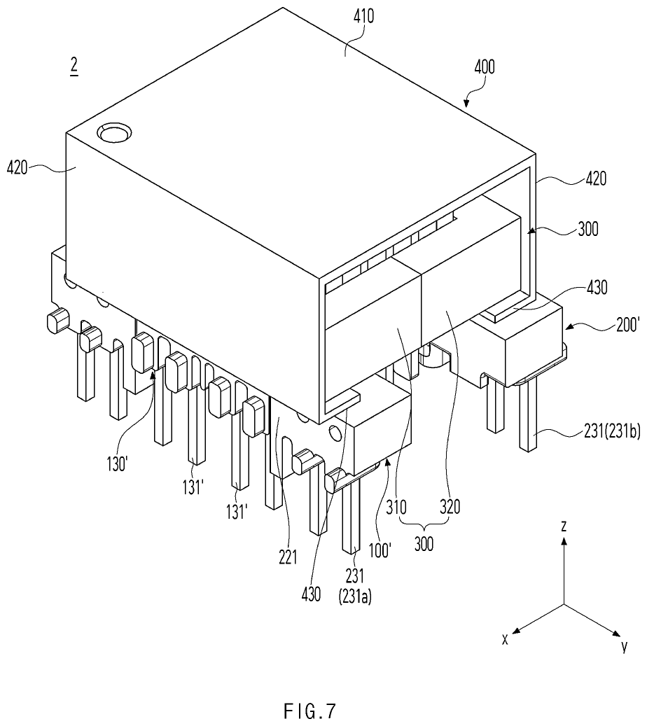

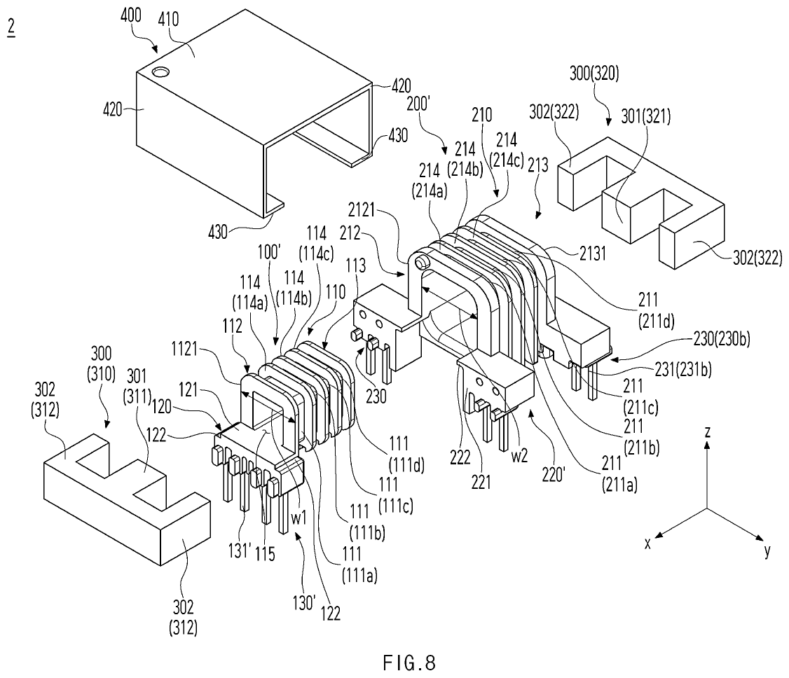

FIG. 7 is a perspective view of the transformer module 2 according to the other embodiment of the present disclosure, and FIG. 8 is an exploded perspective view of the transformer module 2 according to the other embodiment of the present disclosure.

Referring to FIGS. 7 and 8, the transformer module 2 according to the other embodiment of the present disclosure may include a first bobbin unit 100′, a second bobbin unit 200′, a core unit 300, and a cap unit 400. At least a portion of the shape of the first bobbin unit 100′ and at least a portion of the shape of the second bobbin unit 200′ may be different from those in the transformer module 1 according to the disclosed embodiment of the present disclosure described above.

In more detail, the first bobbin unit 100′ may include a first terminal portion 130′. The first terminal portion 130′ may protrude in one direction (e.g., the lower direction) from one end of a first extension part 120 that extends outward from one end of a first winding part 110 by a certain length. The first terminal portion 130′ may include a plurality of first terminals 131′. The second bobbin unit 200′ may include a second terminal portion 230. The second terminal portion 230 may protrude in one direction (e.g., the lower direction) from one end of a second extension part 220′ that extends outward from one end and/or opposite ends of a second winding part 210 by a certain length. The second terminal portion 230 may include a plurality of second terminals 231.

Meanwhile, in the transformer module 2 according to the other embodiment of the present disclosure, the first terminal portion 130′ and a one-side second terminal portion 230a of the second terminal portion 230 may be arranged on the same line. That is, the plurality of first terminals 131′ of the first terminal portion 130′ and the plurality of second terminals 231 of the one-side second terminal portion 230a of the second terminal portion 230 may be arranged on a straight line (e.g., a virtual straight line parallel to the y-axis). When the first terminal portion 130′ and the second terminal portion 230 are arranged on the same line, a safe distance between the first terminal portion 130′ and the second terminal portion 230 may be short, and thus the transformer module 2 may be applied to a relatively low-voltage and low-power system (e.g., a 400V-class system) to perform a transformer function. In addition, the length occupied by the first bobbin unit 100′ may be shortened by the first terminal portion 130′, and thus the transformer module 2 according to the other embodiment of the present disclosure may minimize the area that the transformer module 2 occupies when mounted on a substrate.

Hereinafter, the transformer module 3 according to another embodiment of the present disclosure will be described. In describing the transformer module 3 according to the other embodiment of the present disclosure, contents identical to the above-described ones will be briefly described or will be omitted from the description.

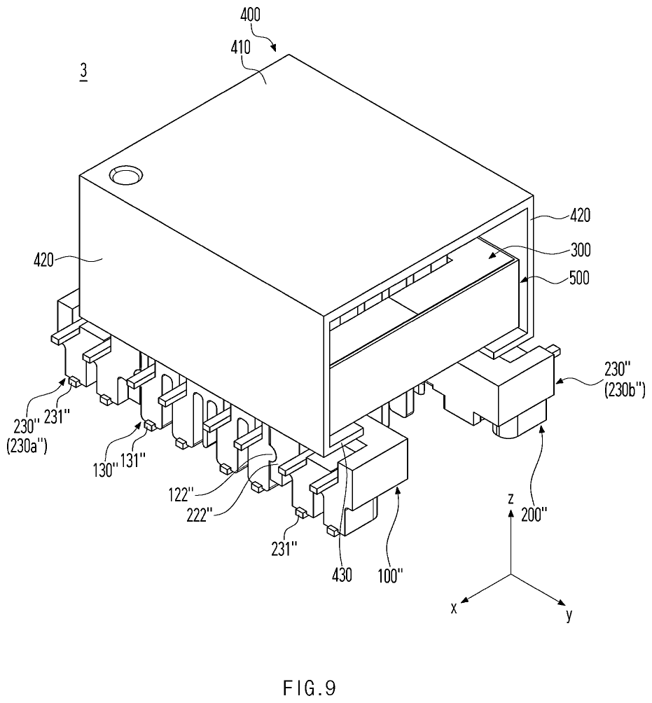

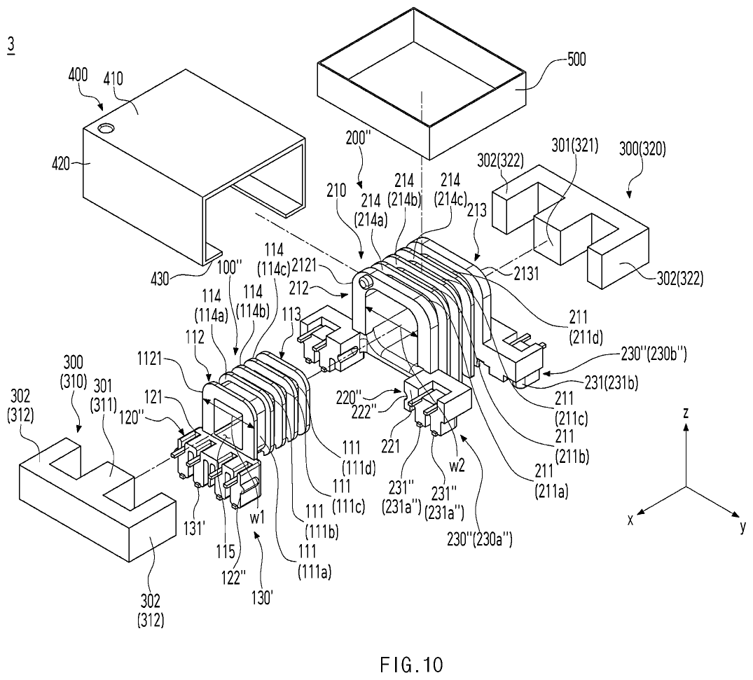

FIG. 9 is a perspective view of the transformer module 3 according to the other embodiment of the present disclosure, and FIG. 10 is an exploded perspective view of the transformer module 3 according to the other embodiment of the present disclosure.

Referring to FIGS. 9 and 10, the transformer module 3 according to the other embodiment of the present disclosure may include a first bobbin unit 100″, a second bobbin unit 200″, a core unit 300, and a cap unit 400.

The first bobbin unit 100″ may include a first extension part 120″ that extends outward from one end of a first winding part 110 by a certain length, and the second bobbin unit 200″ may include a second extension part 220″ that extends outward from one end and/or opposite ends of a second winding part 210 by a certain length. In this case, the first extension part 120″ may include a side protruding portion 122″ rather than the above-described second step portion 122. For example, the first extension part 120″ may include the side protruding portion 122″ that protrudes outward in the width direction (e.g., opposite directions parallel to the y-axis). The side protruding portion 122″ may be formed at a middle height of the first extension part 120″. The side protruding portion 122″ may have a semicircular cross-section. However, the position where the side protruding portion 122″ is formed and the shape of the side protruding portion 122″ may be modified in some cases.

The second extension part 220″ may include a side receiving portion 222″ rather than the above-described second fixing portion 222. For example, the side receiving portion 222″ may be recessed outward in the width direction (e.g., opposite directions parallel to the y-axis) and may have a position and a shape that correspond to the position and the shape of the side protruding portion 122″. For example, when the side protruding portion 122″ has a semicircular cross-section at the middle height of the first extension part 120″, the side receiving portion 222″ may have a semicircular recessed cross-section at a middle height of the second extension part 220″.

Since the side protruding portion 122″ and the side receiving portion 222″ have mutually corresponding shapes, in a process in which the first winding part 110 of the first bobbin unit 100″ is inserted to be accommodated in the second winding part 210 of the second bobbin unit 200″, a kind of rail structure may be formed to guide the insertion of the first winding part 110. That is, the side protruding portion 122″ may be accommodated in the side receiving portion 222″ to guide the insertion of the first winding part 110 into the second winding part 210. Depending on the relationship between the corresponding shapes of the side protruding portion 122″ and the side receiving portion 222″, a movement of the first winding part 110 of the first bobbin unit 100″ in the up-down direction may be limited after the first winding part 110 of the first bobbin unit 100″ is accommodated in the second winding part 210 of the second bobbin unit 200″, and thus the first bobbin unit 100″ may be located in a correct position with respect to the second bobbin unit 200″ to form a stable assembly structure.

Meanwhile, in the transformer module 3 according to the other embodiment of the present disclosure, the first bobbin unit 100″ may include a first terminal portion 130″, and the second bobbin unit 200″ may include a second terminal portion 230″. In more detail, the first bobbin unit 100″ may include the first terminal portion 130″ including a plurality of first terminals 131″ protruding from one end of the first extension part 120″ that extends outward from the one end of the first winding part 110 by the certain length, and the second bobbin unit 200″ may include the second terminal portion 230″ including a plurality of second terminals 231″ protruding from one end of the second extension part 220″ that extends outward from the one end and/or the opposite ends of the second winding part 210 by the certain length. The second terminal portion 230″ may include a one-side second terminal portion 230″a formed at one end with respect to the second winding part 210 and an opposite-side second terminal portion 230″b formed at an opposite end with respect to the second winding part 210. Each of the plurality of first terminals 131″ and the plurality of second terminals 231″ may extend in the longitudinal direction (e.g., a direction parallel to the x-axis) and/or the width direction (e.g., a direction parallel to the y-axis). That is, since each of the plurality of first terminals 131″ and the plurality of second terminals 231″ has a structure extending in the longitudinal direction or the width direction, the transformer module 3 according to the other embodiment of the present disclosure may function as a surface mount device (SMD). As described above, at least one of the first terminal portion 130″ of the first bobbin unit 100″ or the second terminal portion 230″ of the second bobbin unit 200″ may extend horizontally (in the width direction or the longitudinal direction of the bobbin unit) so as to be surface mounted on a substrate. Thus, the number of holes formed in the substrate may be decreased, and the space utilization of the substrate may be improved.

The transformer module 3 according to the other embodiment of the present disclosure may further include a bending unit 500. The bending unit 500 may be formed to surround at least a portion of the outer surface of the core unit 300 described above. In more detail, the bending unit 500 may be formed to surround the lateral periphery of the core unit 300. The inner surface of the bending unit 500 may have a shape corresponding to the outer surface of the core unit 300 and may stably surround the core unit 300. The bending unit 500 may stably couple a first core unit 310 and a second core unit 320 of the core unit 300 such that the first core unit 310 and the second core unit 320 are not separated from each other. In addition, the bending unit 500 may prevent the outer surface of the core unit 300 from making direct contact with the cap unit 400, thereby minimizing an influence of the cap unit 400 on the core unit 300.

According to the above-described contents, the transformer module 1 according to the disclosed embodiment of the present disclosure may decrease parasitic capacitance generated in a power conversion process and may minimize noise.

At least a portion of the first bobbin unit 100 may be accommodated in the second bobbin unit 200. Thus, the transformer module 1 according to the disclosed embodiment of the present disclosure may be made compact, and an electronic product including the transformer module 1 may be made compact.

In the transformer module 1 according to the disclosed embodiment of the present disclosure, the primary coil and the secondary coil may be physically spaced apart from each other through the dual structure of the first bobbin unit 100 and the second bobbin unit 200, and electrical interference and/or a short circuit between the coils may be prevented.

In the transformer module 1 according to the disclosed embodiment of the present disclosure, the plurality of channels may be easily formed by the at least one winding area partition unit 114 or 214 included in each of the first bobbin unit 100 and the second bobbin unit 200.

In the transformer module 1 according to the disclosed embodiment of the present disclosure, the difference in capacitance between the plurality of channels may be minimized, and thus the electrical stability of the transformer module 1 may be improved.

The primary coil wound around the outer peripheral surface of a portion of the first bobbin unit 100 may be safely protected from an external environment by the coupling structure of the first bobbin unit 100 and the second bobbin unit 200.

The first terminal portion 130 of the first bobbin unit 100 may be spaced apart from the second terminal portion 230 of the second bobbin unit 200 at a certain interval by the first extension part 120. Thus, the transformer module 1 may be applied to a relatively high-voltage and high-power system.

When the first terminal portion 130 of the first bobbin unit 100′ and the second terminal portion 230 of the second bobbin unit 200′ are formed on the same line, the transformer module 2 may be applied to a relatively low-voltage and low-power system and may have a more compact structure, thereby minimizing the space occupied.

At least one of the first terminal portion 130″ of the first bobbin unit 100″ or the second terminal portion 230″ of the second bobbin unit 200″ may extend horizontally (in the width direction or the longitudinal direction of the bobbin unit) so as to be surface mounted on the substrate. Thus, the number of holes formed in the substrate may be decreased, and the space utilization of the substrate may be improved.

The cap unit 400 may cover at least a portion of the first bobbin unit 100, at least a portion of the second bobbin unit 200, and at least a portion of the core unit 300. Thus, the first bobbin unit 100, the second bobbin unit 200, and the core unit 300 may be safely protected from an external environment.

The core unit 300 may form a stable coupling structure by the bending unit 500 that covers the outer surface of the core unit 300.

In addition, the structural features and effects obtained by the components commonly included in the transformer module 1 according to the disclosed embodiment of the present disclosure and the transformer module 2 and the transformer module 3 according to the other embodiments of the present disclosure may be mutually shared.

As described above, the transformer module according to the disclosed embodiment of the present disclosure may decrease parasitic capacitance generated in a power conversion process and may minimize noise.

At least a portion of the first bobbin unit may be accommodated in the second bobbin unit. Thus, the transformer module according to the disclosed embodiment of the present disclosure may be made compact, and an electronic product including the transformer module may be made compact.

In the transformer module according to the disclosed embodiment of the present disclosure, the primary coil and the secondary coil may be physically spaced apart from each other through the dual structure of the first bobbin unit and the second bobbin unit, and electrical interference and/or a short circuit between the coils may be prevented.

In the transformer module according to the disclosed embodiment of the present disclosure, the plurality of channels may be easily formed by the at least one winding area partition unit included in each of the first bobbin unit and the second bobbin unit.

In the transformer module according to the disclosed embodiment of the present disclosure, the difference in capacitance between the plurality of channels may be minimized, and thus the electrical stability of the transformer module may be improved.

The primary coil wound around the outer peripheral surface of a portion of the first bobbin unit may be safely protected from an external environment by the coupling structure of the first bobbin unit and the second bobbin unit.

The first terminal portion of the first bobbin unit may be spaced apart from the second terminal portion of the second bobbin unit at a certain interval by the first extension part. Thus, the transformer module may be applied to a relatively high-voltage and high-power system.

When the first terminal portion of the first bobbin unit and the second terminal portion of the second bobbin unit are formed on the same line, the transformer module may be applied to a relatively low-voltage and low-power system and may have a more compact structure, thereby minimizing the space occupied.

At least one of the first terminal portion of the first bobbin unit or the second terminal portion of the second bobbin unit may extend horizontally (in the width direction or the longitudinal direction of the bobbin unit) so as to be surface mounted on the substrate. Thus, the number of holes formed in the substrate may be decreased, and the space utilization of the substrate may be improved.

The cap unit may cover at least a portion of the first bobbin unit, at least a portion of the second bobbin unit, and at least a portion of the core unit. Thus, the first bobbin unit, the second bobbin unit, and the core unit may be safely protected from an external environment.

The core unit may form a stable coupling structure by the bending unit that covers the outer surface of the core unit.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A transformer module comprising:
a first bobbin unit around which a primary coil is wound; and
a second bobbin unit around which a secondary coil is wound, the second bobbin unit being configured to accommodate at least a portion of the first bobbin unit.

2. The transformer module of claim 1, wherein the first bobbin unit includes a first winding part on which the primary coil is wound around a portion of an outer peripheral surface of the first winding part,
wherein the second bobbin unit includes a second winding part on which the secondary coil is wound on a portion of an outer peripheral surface of the second winding part, and
wherein the outer peripheral surface of the first winding part corresponds to an inner peripheral surface of the second winding part and is covered by the second winding part.

3. The transformer module of claim 2, wherein the first winding part includes:
a first winding area where the primary coil is directly wound around an outer peripheral surface of the first winding area;
a first side plate formed at one end of the first winding area to protrude outward from the outer peripheral surface of the first winding area;
a second side plate formed at an opposite end of the first winding area to protrude outward from the outer peripheral surface of the first winding area, the second side plate being configured to face the first side plate; and
at least one first winding area partition unit formed between the first side plate and the second side plate and configured to protrude outward from the outer peripheral surface of the first winding area.

4. The transformer module of claim 3, wherein the second winding part includes:
a second winding area where the secondary coil is directly wound around an outer peripheral surface of the second winding area;
a third side plate formed at one end of the second winding area to protrude outward from the outer peripheral surface of the second winding area;
a fourth side plate formed at an opposite end of the second winding area to protrude outward from the outer peripheral surface of the second winding area, the fourth side plate being configured to face the third side plate; and
at least one second winding area partition unit formed between the third side plate and the fourth side plate and configured to protrude outward from the outer peripheral surface of the second winding area, and
wherein the at least one first winding area partition unit and the at least one second winding area partition unit are formed at the same position in a longitudinal direction.

5. The transformer module of claim 4, wherein each of the at least one first winding area partition unit and the at least one second winding area partition units, is formed in the same number, n, and
wherein each of the primary coil and secondary coil is wound to form (n+1) channels by the at least one first winding area partition unit and at least one second winding area partition units (n being an integer of 1 or more).

6. The transformer module of claim 4,
wherein a second side plate outer surface of the second side plate and a fourth side plate inner surface of the fourth side plate make surface-to-surface contact with each other, and
wherein a first side plate outer surface of the first side plate and a third side plate outer surface of the third side plate are arranged on the same plane by the surface contact between the second side plate outer surface and the fourth side plate inner surface.

7. The transformer module of claim 2, wherein the first bobbin unit further includes a first extension part configured to extend outward from one end of the first winding part by a certain length, and
wherein the first extension part includes:
a first step portion configured to extend in a longitudinal direction from a first side plate formed at one end of a first winding area of the first winding part; and
a second step portion configured to protrude outward from the first step portion in a width direction and form a step of a first thickness with the first step portion.

8. The transformer module of claim 7, wherein the second bobbin unit further includes a second extension part configured to extend outward from one end of the second winding part by a certain length, and
wherein the second extension part includes:
a first fixing portion configured to extend in the longitudinal direction from a third side plate formed at one end of a second winding area of the second winding part; and
a second fixing portion configured to protrude inward from the first fixing portion in the width direction and protrude downward from an upper surface of the first fixing portion by a second thickness.

9. The transformer module of claim 8, wherein the first thickness formed by the first step portion and the second step portion and the second thickness of the second fixing portion correspond to each other to guide insertion of the first winding part into the second winding part, and the first bobbin unit is located in a correct position with respect to the second bobbin unit.

10. The transformer module of claim 2, wherein the first bobbin unit further includes a first terminal portion configured to protrude from one end of a first extension part, the first extension part being configured to extend outward from one end of the first winding part by a certain length,
wherein the second bobbin unit further includes a second terminal portion configured to protrude from one end of a second extension part, the second extension part being configured to extend outward from one end of the second winding part by a certain length, and
wherein the first terminal portion and the second terminal portion are spaced apart from each other.

11. The transformer module of claim 2, wherein the first bobbin unit further includes a first terminal portion configured to protrude from one end of a first extension part, the first extension part being configured to extend outward from one end of the first winding part by a certain length,
wherein the second bobbin unit further includes a second terminal portion configured to protrude from one end of a second extension part, the second extension part being configured to extend outward from one end of the second winding part by a certain length, and
wherein the first terminal portion and a one-side second terminal portion of the second terminal portion are arranged on the same line.

12. The transformer module of claim 2,
wherein the first bobbin unit further includes a first extension part configured to extend outward from one end of the first winding part by a certain length,
wherein the second bobbin unit further includes a second extension part configured to extend outward from one end of the second winding part by a certain length,
wherein the first extension part includes a side protruding portion configured to protrude outward in a width direction,
wherein the second extension part includes a side receiving portion recessed outward in the width direction, the side receiving portion having a shape corresponding to a shape of the side protruding portion, and
wherein the side protruding portion is accommodated in the side receiving portion to guide insertion of the first winding part into the second winding part, and the first bobbin unit is located in a correct position with respect to the second bobbin unit.

13. The transformer module of claim 2, wherein the first bobbin unit further includes a first terminal portion including a plurality of first terminals configured to protrude from one end of a first extension part, the first extension part being configured to extend outward from one end of the first winding part by a certain length,
wherein the second bobbin unit further includes a second terminal portion including a plurality of second terminals configured to protrude from one end of a second extension part, the second extension part being configured to extend outward from one end of the second winding part by a certain length, and
wherein each of the plurality of first terminals and the plurality of second terminals extends in a longitudinal direction or a width direction.

14. The transformer module of claim 2, further comprising:
a cap unit configured to cover at least a portion of the first bobbin unit and at least a portion of the second bobbin unit,
wherein the cap unit covers at least a portion of the outer peripheral surface of the first winding part and at least a portion of the outer peripheral surface of the second winding part.

15. The transformer module of claim 14, wherein the cap unit includes:
a cap unit upper-surface portion configured to cover an upper portion of the second winding part;
a pair of cap unit side portions configured to cover opposite ends of the first winding part and the second winding part; and
a pair of cap fixing portions configured to extend inward from the pair of cap unit side portions toward the first bobbin unit and the second bobbin unit in a longitudinal direction.

16. The transformer module of claim 1, further comprising:
a core unit including a core center portion configured to penetrate the first bobbin unit and the second bobbin unit, and a core side portion spaced apart from the core center portion and configured to cover at least a portion of an outside of the first bobbin unit and at least a portion of an outside of the second bobbin unit.

17. The transformer module of claim 16, further comprising:
a bending unit configured to surround at least a portion of an outer surface of the core unit.
